(19) United States
(12) Patent Application Publication
(10) Pub. No.: US 2009/0236984 A1
(43) Pub. Date: Sep. 24, 2009

(54) 3D Electroluminescent High-Pressure Forming Element, Production Process And Application

(75) Inventors: Thilo-Josef Werners, Leverkusen (DE); Michael Heite, Olpe (DE); Thomas-Hermann Kessler, Bensheim (DE); Klaus Reinartz, Koeln (DE)

Correspondence Address: RANKIN, HILL & CLARK LLP, 23755 Lorain Road - Suite 200, North Olmsted, OH, 44070-2224, US

(73) Assignee: LYTTRON TECHNOLOGY GMBH, Koln (DE)

(21) Appl. No.: 12/306,780

(22) PCT Filed: Jun. 27, 2007
(86) PCT No.: PCT/EP07/56401

§ 371 Date: Mar. 27, 2009

(30) Foreign Application Priority Data
Jul. 1, 2006 (DE) 10 2006 031 315.1

(51) Int. Cl. H01J 1/62; H01J 9/00

(52) U.S. Cl. 313/509; 445/24

(57) ABSTRACT

A three-dimensionally formed film element which can be produced by isostatic high-pressure forming, a process for producing the three-dimensionally formed film element according to the invention and the use of the three-dimensionally formed film element according to the invention for developing display elements such as a speedometer panel for land, water and aircraft, for developing seatbelt signs or warning signs for land, water and aircraft and warning signs in buildings and for developing housing elements for mobile and static electronic devices and for developing a keyboard.

The present invention relates to a three-dimensionally formed film element which can be produced by isostatic high-pressure forming, a process for producing the three-dimensionally formed film element according to the invention and the use of the three-dimensionally formed film element according to the invention for developing display elements such as a speedometer panel for land, water and aircraft, for developing seatbelt signs or warning signs for land, water and aircraft and warning signs in buildings and for developing housing elements for mobile and static electronic devices and for developing a keyboard.

Electroluminescent illuminated surfaces for mobile or static electronic devices are known in the prior art. Such electroluminescent illuminated surfaces are conventionally used as components for the backlighting of display devices and controls. Conventional electroluminescent illuminated surfaces have a polyester film as the support and an electrically conductive, largely transparent layer applied by vapour deposition using the sputtering method. Such electroluminescent illuminated surfaces generally also include further layers, e.g. protective layers. Since these layers used in the prior art for producing electroluminescent illuminated surfaces frequently have a brittle nature or cannot withstand a forming process at high temperatures, the conventional display devices are generally flat in design, which in the case of objects having a three-dimensional geometry, for example, can make them more difficult to read or to operate.

Three-dimensional electroluminescent displays have therefore already been proposed in the prior art.

DE-A 44 30 907 relates to a three-dimensional electroluminescent display having a transparent panel, a translucent layer applied to at least one side of the panel, at least one electroluminescent lamp positioned next to the translucent layer and a substrate moulded onto the electroluminescent lamp and the panel to form an integral three-dimensional electroluminescent display. The three-dimensional electroluminescent display is produced from a preformed panel. It is also mentioned, however, that the panel can also be postformed, i.e. that the three-dimensional electroluminescent display can be formed by customary methods before the substrate is moulded on. However, DE-A 44 30 907 contains no further information about suitable customary methods.

DE-A 102 34 031 relates to an electroluminescent illuminated surface constructed as a capacitor with two parallel electrodes, at least one of which is transparent, and an luminous substance which can be excited by an electric field positioned between the electrodes. The electroluminescent illuminated surface also contains a support layer provided with information details, which is made from a freely formable film material or from a rigid material having a three-dimensionally formed surface, wherein, at least in the area containing the information details, the support layer is provided with a coating congruent to its formed shape comprising a first electrically conductive layer, a pigment layer, an insulating and reflective layer, a top electrode and an optional protective layer. The electroluminescent illuminated surface is produced by first printing the support layer consisting of the freely formable film material or of a rigid material which has previously been brought into a three-dimensionally formed surface shape with information details and then providing it with a first electrically conductive layer, a pigment layer, an insulating and reflective layer, a rear electrode and an optional protective layer. The three-dimensionally formed film body can then be back-moulded with a plastic material to produce a supporting body. If a support layer made from a freely formable film material is used, the printed film body provided with the other layers specified above can be formed, thermoforming being the only forming method mentioned in DE-A 102 34 031.

WO 03/037039 relates to a three-dimensional electroluminescent display comprising a main body and an electroluminescent arrangement. The electroluminescent arrangement consists of a film and an electroluminescent device, the surface of the film facing the electroluminescent device being provided with motifs to be displayed. The electroluminescent device consists of a front electrode and a rear electrode, between which there is a dielectric material. The front electrode is attached to the motif-reproducing layer and forms a single component therewith. A power supply is provided within the surface of the electroluminescent arrangement which is in contact with the electrodes of the electroluminescent arrangement. The main body is made from a suitable plastic which can advantageously be processed by injection moulding. Production of the three-dimensional electroluminescent display begins with the production of the electroluminescent arrangement. First of all the film is prepared which acts as the support for the electroluminescent device. The electroluminescent arrangement is then formed by thermoforming, stamping, embossing or coining, and preferably by thermoforming. After the forming (thermoforming) process, the main body is attached to the rear of the electroluminescent arrangement, for example by back-moulding the electroluminescent arrangement with an appropriate material.

In the production of three-dimensional electroluminescent illuminated surfaces, which preferably include printed information symbols, it is important that the electroluminescent element and the information symbols that are optionally printed thereon retain their exact position and remain warp-free, or that the warp is constant such that it can be balanced out by a tensile force. This cannot be absolutely guaranteed with conventional cold-forming methods such as thermoforming or stamping.

The object of the present invention is therefore to provide a three-dimensionally formed film element having at least one electroluminescent element and optionally provided with graphic images, the at least one electroluminescent element and optionally the graphic images being accurately positioned on the three-dimensionally formed film element.

The object of providing a three-dimensionally formed film element is achieved by a three-dimensionally formed film element constructed from
a) an at least partly transparent support film, component A, consisting of at least one cold-stretching film material, which is optionally provided with graphic images,
b) at least one electroluminescent element, component B, applied to the support film, containing the following components:
   ba) an at least partly transparent electrode, component BA,
   bb) optionally a first insulating layer, component BB,
   bc) a layer containing at least one luminous substance which can be excited by an electric field, component BC,
   bd) optionally a further insulating layer, component BD,
   be) a rear electrode, component BE,
c) a protective layer, component CA, or a film, component CB,
   which can be produced by isostatic high-pressure forming of a flat film element constructed from components A, B and C at a processing temperature below the softening point of component A of the film element.

In addition to the specified layers (components A, B and C), the three-dimensionally formed film element according to the invention can also have additional layers.

The three-dimensional film element according to the invention is characterised in that the at least one electroluminescent element applied to the support film and the graphic images optionally present on the transparent support film are accurately positioned. This is substantial because the three-dimensionally formed film element according to the invention is intended for use for developing speedometer panels for land, water and aircraft, for example, wherein an accurate positioning of the information symbols is important. Such an accurate positioning is achieved by providing a flat film element having components A, B and C, these components being selected such that the flat film element can be formed three-dimensionally by isostatic high-pressure forming. Surprisingly it was found that such three-dimensional forming by isostatic high-pressure forming is possible in the presence of an electroluminescent element comprising components BA, BB, optionally BC and BD.

The three-dimensionally formed film elements according to the invention are sufficiently dimensionally stable for numerous applications, so back-moulding of the film element with a suitable plastic, as proposed in the prior art cited above, is not necessary. In a preferred embodiment, the present invention thus relates to a three-dimensionally formed film element constructed from components A, B and C, wherein the three-dimensionally formed film element has no moulded-on substrate and in particular is not back-moulded with a plastic.

### Component A

The three-dimensional film element according to the invention contains an at least partly transparent support film, component A, consisting of at least one cold-stretching film material, which is optionally provided with graphic images.

An “at least partly transparent support film” is understood to mean both transparent support films and those which are translucent but not fully transparent. The support film is constructed according to the invention from at least one cold-stretching film material. This is necessary so that the three-dimensionally formed film element can be produced by isostatic high-pressure forming at a processing temperature below the softening point of component A. Suitable cold-stretching film materials are cited for example in EP-A 0 371 425. Both thermoplastic and thermoset at least partly transparent cold-stretching film materials can be used. Cold-stretching film materials are preferably used which display little or no resilience at room temperature and service temperature. Particularly preferred film materials are selected from at least one material from the group consisting of polycarbonates, preferably polycarbonates based on bisphenol A, for example the Makrofol®, grades sold by Bayer MaterialScience AG, polyesters, in particular aromatic polyesters, for example polyalkylene terephthalates, polyamides, for example PA 6 or PA 6.6 grades, high-strength “aramide films”, polyimides, for example the poly(diphenyloxide pyromellitic imide)-based films sold under the trade name Kapton®, polyarylates, organic thermoplastic cellulose esters, in particular acetates, propionates and acetobutyrates thereof, for example film materials sold by Bayer MaterialScience AG under the trade name Cellidor®, and polyfluorinated hydrocarbons, in particular the copolymers of tetrafluoroethylene and hexafluoropropylene known by the name FEB, which are available in transparent form. Preferred film materials for the support film are chosen from polycarbonates, for example the Makrofol® grades sold by Bayer MaterialScience AG, polyesters, in particular aromatic polyesters, for example polyalkylene terephthalates, and polyimides, for example the poly(diphenyloxide pyromellitic imide)-based films sold under the trade name Kapton®. Polycarbonates based on bisphenol A are most particularly preferably used as film materials, in particular films known as Bayfol® CR (polycarbonate/polybutylene terephthalate film), Makrofol® TP or Makrofol® DE from Bayer MaterialScience AG.

The at least partly transparent support film used according to the invention can have one surface that is satinised or rough, or high-gloss surfaces on both sides. The film thickness of the at least partly transparent support film used according to the invention is generally 40 to 2000 μm. With higher film thicknesses, the sudden forming which occurs with isostatic high-pressure forming often causes the material to become brittle. A support film with a film thickness of 50 to 500 μm is preferably used, particularly preferably 100 to 400 μm, most particularly preferably 150 to 375 μm.

In a preferred embodiment, depending on the use of the three-dimensionally formed film element according to the invention, the at least partly transparent support film is provided with graphic images. These can be information symbols, such that letters, numbers, symbols or pictograms for example are visible on the surface of the three-dimensionally formed film element. The graphic design is preferably a printed graphic design, in particular an inked impression. In a particularly preferred embodiment the support film used according to the invention is provided with graphic images in the form of opaque or translucent inked impressions. These inked impressions can be produced by any method known to the person skilled in the art, for example by screen printing, offset lithography, serigraphy, rotary printing, intaglio printing or flexographic printing, all of which are customary and known in the prior art. The graphic design is preferably produced by the application of ink using screen printing, since pigmented inks having high film thicknesses and good formability can be applied by screen printing.

The printing inks used for the graphic design must be adequately formable under the conditions of isostatic high-pressure forming. Suitable inks, particularly screen printing inks, are known to the person skilled in the art. For example, inks having a plastic ink carrier, based on polyurethane for example, can be used. These screen printing inks have excellent adhesion to the film material of the support film used according to the invention. Screen printing inks based on aqueous dispersions of aliphatic polyurethanes are particularly preferably used. Suitable inks are available for example under the trade name AquaPress PR® from Pröll, Weissenburg. Other suitable screen printing inks are those based on high-temperature-resistant thermoplastics, in particular screen printing inks with the trade name Noriphan® from Pröll, Weissenburg.

### Component B

The three-dimensionally formed film element according to the invention contains at least one electroluminescent element as component B applied to the support film.

The electroluminescent element contains the following components:
ba) an at least partly transparent electrode, component BA,
bb) optionally a first insulating layer, component BB,
bc) a layer containing at least one luminous substance which can be excited by an electric field, component BC,
bd) optionally a further insulating layer, component BD,
be) a rear electrode, component BE.

The electroluminescent element can also include further components in addition to those specified above. For example, there can be additional layers between the rear electrode, component BE, and the optionally further insulating layer, component BD (or, if the insulating layer is not present, between component BE and component BC). Component BD (or, if that is not present, component BC), can be followed by a further structure comprising an at least partly transparent electrode, a further layer containing at least one luminous substance which can be excited by an electric field, and optionally a further insulating layer. This structure can optionally be repeated once more, the last component of the structure being followed by the rear electrode, component BE.

Suitable electroluminescent elements are known to the person skilled in the art. Surprisingly it was found that film elements having at least one electroluminescent element used according to the invention can be formed by isostatic high-pressure forming, such that the three-dimensionally formed film elements according to the invention can be obtained.

It is known to the person skilled in the art that the at least one electroluminescent element used according to the invention is in contact with a power supply. To this end, the at least one electroluminescent element generally has electrical connections routed along a side edge of the film element according to the invention, where they are placed in contact with a power supply by means of contacting aids. Suitable contacting aids are for example crimps, clamps, electrically conductive adhesives, screws and other means known to the person skilled in the art. The electroluminescent element can be controlled in a conventional manner known to the person skilled in the art.

The electroluminescent element is placed in contact with a power source using a plurality of leads which are connected to the aforementioned contacting aids. The leads are generally made from a conductive material, for example copper, and can be produced using a punching tool and process according to methods known in the prior art. Alternatively, the leads can be in tracks of conductive pastes, for example ink, produced by screen printing, which lead to the electrical connections of the at least one electroluminescent element.

The electroluminescent element is generally operated with alternating current. Electroluminescent inverters (EL inverters) are used to generate the alternating current. Suitable EL inverters are known to the person skilled in the art and are commercially available. In a preferred embodiment, EL inverters in the form of SMD (surface mounted device) components are used. Suitable SMD EL inverters are likewise known to the person skilled in the art and are commercially available. The advantage of SMD EL inverters is that they have no wire connectors and instead can be placed in contact with the electroluminescent element using polymeric conductive adhesives known to the person skilled in the art. In a development of the present invention, the EL inverters in the form of SMD components are therefore attached directly to the back of the film element constructed from components A, B and C, generally using polymeric bonding methods including the establishing of electrical contact with the wiring paths on the electroluminescent element. In this way, for example, 12 volt DC voltage connection elements can be produced on bordering edges of the three-dimensionally formed film element constructed from components A, B and C.

Following the mechanical and electrical installation of the SMD EL inverters, passivating and adhesion-improving embedding compounds are generally additionally applied, using a dispenser for example.

Small-area electroluminescent fields, generally up to around 50 mm², can be operated very efficiently for example by the HV850 EL lamp driver SMD component from Supertex, Inc., Sunnyvale, Calif., USA, which measures around 3 mm×3 mm×1 mm (H×W×D), with no additional induction coil component being required in this case.

The electroluminescent elements used as component B in the three-dimensionally formed film element according to the invention are generally thick-film electroluminescent elements running on alternating current (thick-film AC EL elements). One advantage of these thick-film AC EL elements is that relatively high voltages of in general more than 100 volts, peak-to-peak, preferably between 100 volts, peak-to-peak and 140 volts, peak-to-peak, at several 100 Hz in the kHz range (1000 Hz), preferably 250 Hz to 800 Hz, particularly preferably 250 Hz to 500 Hz, are used, and when the layer is formed containing at least one luminous substance which can be excited by an electric field, component BC (dielectric layer), there is virtually no ohmic power loss. The electrical conductivity of the electrodes (components BA and BE) should therefore be as uniform as possible, although no particular current load occurs. Highly conductive busbars are preferably used, however, to reduce voltage drops.

The electroluminescent elements (component B) used in the film element according to the invention are generally operated at a brightness of 10 cd/m² to 500 cd/m², preferably 10 cd/m² to 100 cd/m². If microencapsulated ZnS electroluminophores containing at least one luminous substance which can be excited by an electric field are used in the layer, half-life values of generally around 2000 hours can be achieved. In principle, the operation of such electroluminescent elements with an AC voltage having a harmonic waveform is preferred. Transient voltage surges should be avoided. In particular, the start-up and shutdown process is preferably designed in such a way that no excessive voltage surges can damage the layer containing at least one luminous substance which can be excited by an electric field (dielectric material) and optionally also damage individual luminous substances (electroluminophores). The reduction in brightness over the lifetime, known as the half-life, in other words the time until the initial brightness has reduced by half, can be compensated for by adjusting the voltage supply or optionally by adjusting the frequency. The adjustment can be made both by reducing the capacity of the electroluminescent element and by means of an external photodiode which measures electroluminescent emissions. In certain areas, changing the frequency can also influence the emission colour of the electroluminescent emission.

In a further preferred embodiment of the present invention, the three-dimensionally formed film element according to the invention can contain an LED element in addition to the at least one electroluminescent element. It is preferably an SMD LED element. Suitable LED elements are known to the person skilled in the art and are commercially available.

The present invention therefore also provides a three-dimensionally formed film element constructed from components A, B and C and additionally at least one LED element, preferably at least one SMD LED element, as component D, wherein the three-dimensionally formed film element can be produced by isostatic high-pressure forming of a flat film element constructed from components A, B, C and D at a processing temperature below the softening point of component A of the film element.

The SMD LED modules are preferably positioned on the rear of the three-dimensionally formed film elements constructed from components A, B and C, e.g. by gluing by methods known to the person skilled in the art.

LED elements conventionally display a point-like light emission of very high luminance and so behind a translucent information field having a signalling impact, for example, they can therefore generate higher light intensities than flat electroluminescent elements. Three-dimensionally formed film elements according to the invention having LED elements are therefore very suitable for use as alarm signal elements. Furthermore, in a further preferred embodiment the translucent luminous fields are provided with diffuser elements by printing or by means of a dispenser, such that the SMD LED element has broad radiant emission characteristics and can therefore be used as a visual signal for an alarm state, for example to indicate overheating or a low oil level or the failure of the ABS braking system, etc. Suitable diffuser elements are known to the person skilled in the art and are commercially available.

The electroluminescent element used according to the invention includes an at least partly transparent electrode. An “at least partly transparent” electrode is understood to mean an electrode which can be completely transparent or an electrode which can be translucent but not completely transparent.

The at least partly transparent electrode is generally a two-dimensional electrode constructed from one or more electrically conductive materials on an inorganic or organic basis. Suitable at least partly transparent electrodes which can be used according to the invention are all electrodes known to the person skilled in the art for producing electroluminescent elements which are not damaged by forming to produce the three-dimensionally formed film element according to the invention by isostatic high-pressure forming. Thus conventional indium tin oxide (ITO) sputter layers on heat-resistant polyester films as mentioned in the prior art are suitable in principle but are not preferred, however. Polymeric electrically conductive highly transparent coatings or design-specific screen-printing films are preferably used.

The at least partly transparent electrode used according to the invention is thus preferably selected from the group consisting of ITO screen-printing films, ATO (antimony tin oxide) screen-printing films, non-ITO screen printed layers (the term “non-ITO” encompassing all screen-printing films not based on indium tin oxide (ITO)), i.e. intrinsically conductive polymeric layers having conventionally nanoscale electrically conductive pigments, for example the ATO screen printing pastes with reference numbers 7162E or 7164 from DuPont, intrinsically conductive polymer systems such as the Orgacon® system from Agfa, the Baytron® poly-(3,4-ethylene dioxythiophene) system from H.C. Starck GmbH, the system described as an organic metal (PEDT conductive polymer polyethylene dioxythiophene) from Ormecon, conductive coating or printing ink systems from Panipol OY, and optionally having highly flexible binders, based for example on PU (polyurethanes), PMMA (polymethyl methacrylate), PVA (polyvinyl alcohol), modified polyaniline. The Baytron® poly-(3,4-ethylene dioxythiophene) system from H. C. Starck GmbH is preferably used as the material for the at least partly transparent electrode of the electroluminescent element.

The at least partly transparent electrode of the electroluminescent element is generally connected directly to the at least partly transparent support film optionally provided with graphic images.

In addition to the at least partly transparent electrode, component BA, the electroluminescent element used according to the invention contains a layer containing at least one luminous substance which can be excited by an electric field as component BC. The layer is generally applied to an optionally present first insulating layer, component BB, or, if this layer is not present, to the at least partly transparent electrode. The luminous substance which can be excited by an electric field (luminophore) in the layer (component BC) is preferably ZnS, which is generally doped with phosphorus.

The layer (component BC) is conventionally a dielectric material. This material can for example be ZnS, generally doped with phosphorus, or a mixture of ZnS, generally doped with phosphorus (as the luminous substance), BaTiO₃ and highly flexible binders, for example those based on PU, PMMA, PVA.

In addition to components BA and BB, the electroluminescent element according to the invention can contain an insulating layer as component BC, which is generally applied to the layer containing at least one luminous substance which can be excited by an electric field. A suitable material for an insulating layer is barium titanate (BaTiO₃), for example.

The at least one electroluminescent element used according to the invention also contains a rear electrode, component BD. This is generally applied to the insulating layer, if present. If no insulating layer is present, the rear electrode is applied to the layer containing at least one luminous substance which can be excited by an electric field.

As with the at least partly transparent electrode, the rear electrode is a two-dimensional electrode which does not however have to be transparent or at least partly transparent. This is generally constructed from electrically conductive materials on an inorganic or organic basis, materials preferably being used which are not damaged by the isostatic high-pressure forming method used to produce the three-dimensionally formed film element according to the invention. Suitable electrodes are therefore in particular polymeric electrically conductive coatings. The coatings already specified above with regard to the at least partly transparent electrode can be used. In addition, such polymeric electrically conductive coatings known to the person skilled in the art which are not at least partly transparent can be used.

Suitable materials for the rear electrode are thus preferably selected from the group consisting of metals such as silver, carbon, ITO screen-printing films, ATO screen-printing films, non-ITO screen-printing films, i.e. intrinsically conductive polymer systems having conventionally nanoscale electrically conductive pigments, for example ATO screen printing pastes with reference numbers 7162E or 7164 from DuPont, intrinsically conductive polymer systems such as the Orgacon® system from Agfa, the Baytron® poly-(3,4-ethylene dioxythiophene) system from H. C. Starck GmbH, the system described as an organic metal (PEDT conductive polymer polyethylene dioxythiophene) from Ormecon, conductive coating and printing ink systems from Panipol Oy, and optionally having highly flexible binders, based for example on PU (polyurethanes), PMMA (polymethyl methacrylate), PVA (polyvinyl alcohol), modified polyaniline, wherein metals such as silver or carbon can be added to the aforementioned materials to improve their electrical conductivity and/or they can be supplemented with a layer of these materials.

The electroluminescent element can be produced for example by applying the individual layers by the so-called thick-film method known in the prior art.

The layers of the electroluminescent element are applied to the support film by methods known to the person skilled in the art. The electroluminescent element is generally connected to the support film by being directly applied, for example by screen printing, to the support film.

### Component C

In addition to components A and B, the three-dimensionally formed film element according to the invention contains a protective layer, component CA, to prevent the electroluminescent element or the optionally present graphic images from being destroyed. Suitable materials for the protective layer are known to the person skilled in the art. Suitable protective layers CA are for example high-temperature-resistant protective lacquers such as protective lacquers containing polycarbonates and binders, for example Noriphan® HTR from Pröll, Weissenburg.

Depending on the application, the three-dimensionally formed film element according to the invention can contain in addition to components A and B, in place of the protective layer component, CA, a film, component CB. Suitable films are the films specified as support films (component A). The films can be applied by laminating or gluing, for example.

The three-dimensionally formed film element according to the invention can be produced by isostatic high-pressure forming of a flat film element constructed from components A, B and C at a processing temperature below the softening point of component A of the film element. A suitable isostatic high-pressure forming process is mentioned for example in EP-A 0 371 425. The construction according to the invention from components A, B and C as described above ensures that a three-dimensional forming of the flat film element by isostatic high-pressure forming can take place without damaging the individual components of the film element, in particular without impairing the lamp function of the electroluminescent element.

The layers (components A, B and C) in the film element according to the invention are matched so as to avoid short-circuits. The effect of the protective layer, component C, on the rear is to allow forming without cracking. Since a flat film element constructed from elements A, B and C is formed by isostatic high-pressure forming, it is particularly important that good adhesion of the individual layers of the film element is ensured. The good adhesion is ensured by the composition of the individual layers (components A, B and C), in particular by the use of highly flexible binders in the layers, e.g. binders based on PU, PMMA, PVA, in particular PU. The composition of the layers (components A, B and C) ensures not only excellent adhesion of the layers to one another but also the necessary extensibility to perform the isostatic high-pressure forming.

The three-dimensionally formed film element according to the invention can be produced by isostatic high-pressure forming as disclosed for example in EP-A 0 371 425. The present invention therefore also provides a process for producing a three-dimensionally formed film element comprising
i) production of a flat film element constructed from
   a) an at least partly transparent support film, component A, consisting of at least one cold-stretching film material, which is optionally provided with graphic images,
   b) at least one electroluminescent element, component B, applied to the support film, containing the following components:
      ba) an at least partly transparent electrode, component BA,
      bb) optionally a first insulating layer, component BB,
      bc) a layer containing at least one luminous substance which can be excited by an electric field, component BC,
      bd) optionally a further insulating layer, component BD,
      be) a rear electrode, component BE,
   c) a protective layer, component CA, or a film, component CB, and
ii) isostatic high-pressure forming of the flat film element obtained in step i) at a processing temperature below the softening point of component A of the film element.

Components A, B and C have the meanings given above. In addition to components A, B and C, the three-dimensionally formed film element according to the invention can optionally contain further layers.

### Step i)

The flat film element can be produced by methods known to the person skilled in the art.

In a preferred embodiment, production of the flat film element in step i) comprises the following steps:
ia) Providing a transparent support film, component A, and optionally printing the transparent support film with graphic images,
ib) Applying the electroluminescent element to the optionally printed support film,
ic) Applying the protective layer or the film to the electroluminescent element;
   wherein an insulating layer can optionally be applied between steps ia) and ib) and/or between steps ib) and ic).

Production of the transparent support film in step ia) takes place by methods known to the person skilled in the art. Suitable support films are also commercially available. The application of graphic images to the support film can likewise take place by methods known to the person skilled in the art, for example by screen printing, offset lithography, rotary printing, intaglio printing, inkjet printing, pad printing, laser printing or flexographic printing, all of which are customary and known in the prior art. The graphic design is preferably produced by the application of ink using screen printing.

In order to obtain complete coverage without the slightest transparent flaw, multiple printing, for example double printing, can take place. Reference marks or a three-point edge recording system are generally used to position the individual prints.

The application of the electroluminescent element to the optionally printed support film in step ib) can likewise take place by methods known to the person skilled in the art. The electroluminescent element can be connected to the support film by means known to the person skilled in the art, generally by being directly applied, by screen printing for example, to the support film, as already mentioned above.

In step ic) the protective layer or film is likewise applied to the at least one electroluminescent element by methods known to the person skilled in the art, preferably likewise by screen printing.

The insulating layers are likewise preferably applied by screen printing.

One advantage of the film element according to the invention is that all layers of the film element are selected such that they can be applied by screen printing. In a preferred embodiment of the process according to the invention, the optionally performed printing of the transparent support film with graphic images in step ia), application of the electroluminescent element to the optionally printed support film in step ib) and application of the protective layer or film to the electroluminescent element in step ic) are performed by screen printing.

### Step ii)

The isostatic high-pressure forming in step ii) preferably takes place by the method cited in EP-A 0 371 425, wherein a processing temperature is chosen which is below the softening point of component A of the film element.

The flat film element obtained in step i), constructed from components A, B and C, is generally treated with a hydraulic fluid at a working temperature and isostatically formed, the forming taking place at a working temperature below the softening point of the material of the support film (component A) and under a hydraulic fluid pressure of generally >20 bar, preferably >100 bar, particularly preferably 200 to 300 bar. Forming of the film material generally takes place within a cycle time of a few seconds, preferably within a time of <10 seconds, particularly preferably within a time of <5 seconds. Forming rates of 100% to 200% can be achieved without the appearance of visually intrusive stress whitening.

In a preferred embodiment the isostatic high-pressure forming is generally performed at a temperature of at least 5° C., preferably at least 10° C., particularly preferably at least 20° C. or more below the softening point of component A of the film element. The softening point of polycarbonates based on bisphenol A (for example Makrofol® films) which are particularly preferably used as the material of the at least partly transparent support film is approximately around or above 150° C. It is possible for the isostatic high-pressure forming of film elements having such polycarbonate films as the support films to be performed at room temperature. Owing to the other components, inter alia owing to the graphic images, which are preferably produced by printing with ink, the isostatic high-pressure forming preferably takes place at working temperatures of between 80 and 130° C. if polycarbonates based on bisphenol A, as mentioned above, are used as the film material of the support film. If support films made from other materials are used, the processing temperature in step ii) can be determined without difficulty by the person skilled in the art if the softening point of the material is known.

Suitable devices for performing isostatic high-pressure forming to produce the three-dimensionally formed film element according to the invention are cited for example in EP-A0371 425.

The three-dimensionally formed film element obtained at the end of step ii) can be brought into a desired final shape, for example by trimming, punching or laser cutting. Suitable methods and devices for bringing the film element into its final shape, for example by punching, trimming or laser cutting, are known to the person skilled in the art. Punching, trimming or laser cutting is generally performed with a high degree of precision, a suitable trimming process being precision cutting, for example.

The three-dimensionally formed film element according to the invention can be used in many applications. Suitable applications are for example the use of the three-dimensionally formed film element according to the invention to develop display elements such as a speedometer panel for land, water and aircraft, to develop seatbelt signs or warning signs in land, water and aircraft and to develop warning signs in buildings, to develop housing elements for mobile electronic devices, for example a mobile telephone or a remote control, and housing elements for static electronic devices such as a printer, photocopier, PC, notebook or a small or large domestic appliance or to develop a keyboard.

A number of embodiment examples of the invention are described below in more detail by reference to figures.

The content of the figures is as follows:

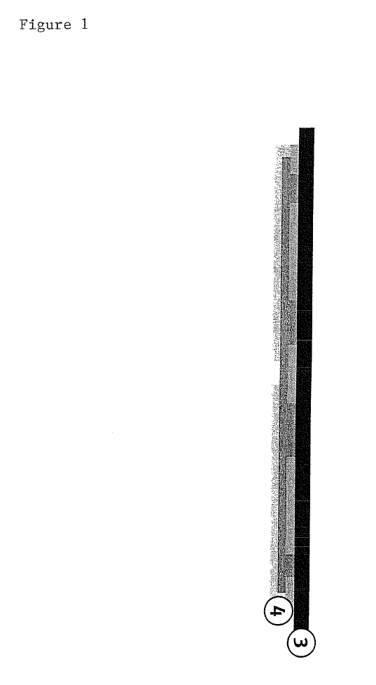

FIG. 1: A schematic cross-section A-B through a not yet three-dimensionally formed film element (3) in the area of a speedometer panel (15)

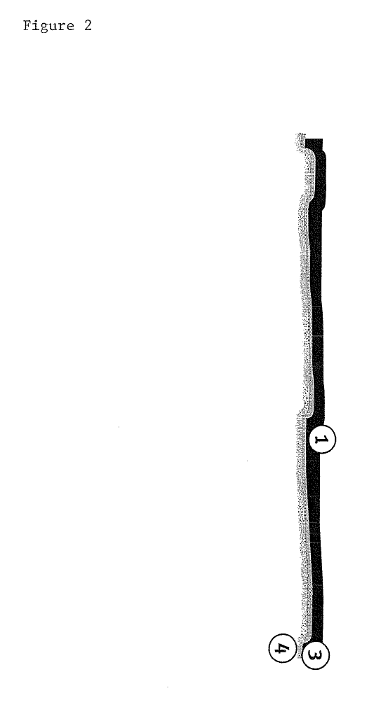

FIG. 2: A schematic cross-section A-B through a three-dimensionally formed film element (3) in the area of a speedometer panel (15)

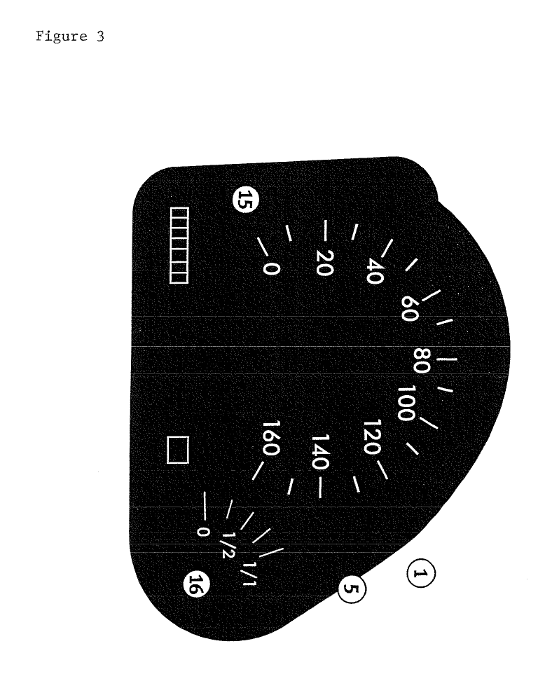

FIG. 3: A schematic view of an example of a punched or trimmed (5) formed three-dimensional film element according to the invention (3D EL HPF) (1)

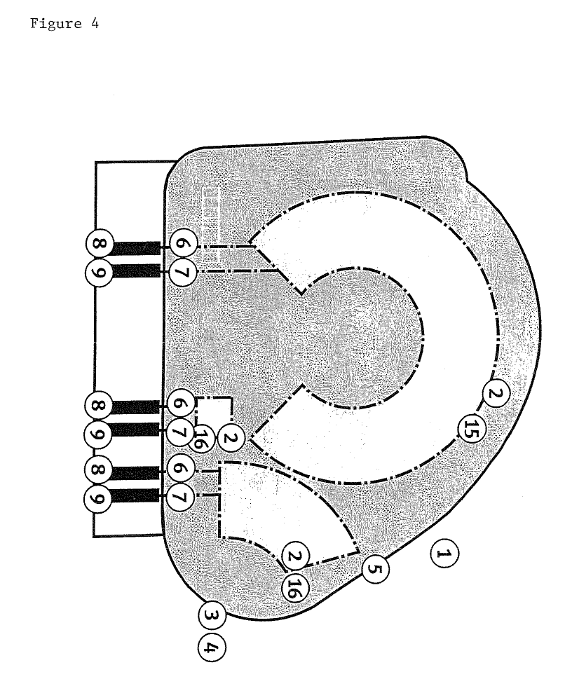

FIG. 4: A schematic view of an example of a three-dimensionally formed film element according to the invention (3D EL HPF) (1) with 3 EL elements (2, 15, 16)

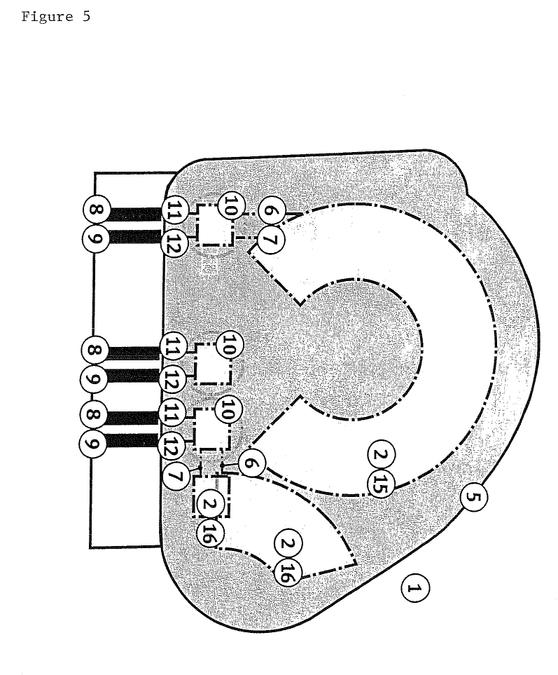

FIG. 5: A schematic view of an example of a 3D EL HPF element (1) with three EL elements (2, 15, 16) and surface-mounted SMD EL inverter elements (10)

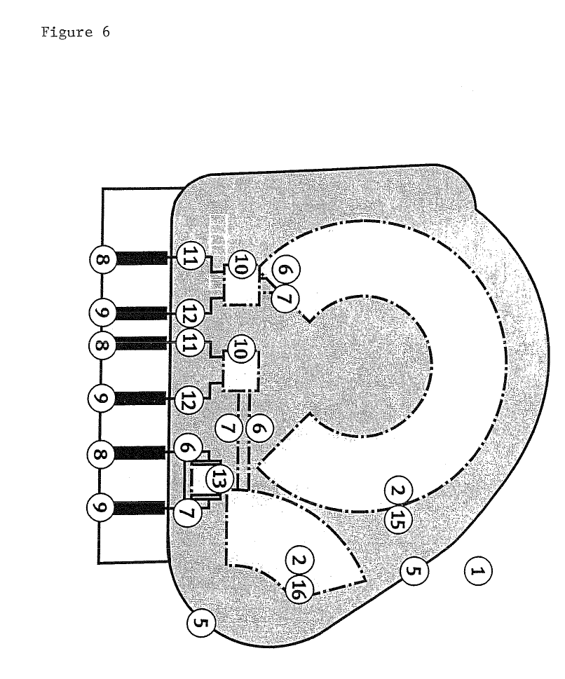

FIG. 6: A schematic view of an example of a 3D EL HPF element (1) with two EL elements (2, 15, 16) and surface-mounted SMD EL inverter elements (10) and an SMD LED element (13)

FIG. 1 shows a schematic cross-section A-B through a not yet three-dimensionally formed film element (3) in the area of a speedometer panel (15). For the sake of simplicity, the various printed layers (4) are not shown in any greater detail because these printing technologies correspond to the prior art.

FIG. 2 shows a schematic cross-section A-B through a three-dimensionally formed film element (3) in the area of a speedometer panel (15). For the sake of simplicity, the various printed layers (4) are not shown in any greater detail because these printing technologies correspond to the prior art.

FIG. 3 shows a schematic view of an example of a punched or trimmed (5) formed film element according to the invention (3D EL HPF). After trimming or punching, the shape (5) is conventionally somewhat smaller than the printed shape (5) in FIG. 2. In this example a speedometer display (15) and a fuel level display (16) are used to illustrate the invention. Such 3D EL HPF elements (1) must be shaped with great precision, and the graphic design must be accurately positioned, since a hole is produced in the centre, for example, through which a pointer element is passed which indicates the speed. The backlighting is produced according to the invention using electroluminescent (EL) elements (2).

FIG. 4 shows a schematic view of an example of a 3D EL HPF element (1) with three electroluminescent (EL) elements (2, 15, 16). Instead of the hitherto conventional backlighting method of the prior art, the printed EL elements (2) are only required in the places where a graphic translucent view is required (15, 16). The various electroluminescent elements (2) (electroluminescent fields) are produced according to the prior art and the electrical connections (6, 7) to the connections at the edge (8, 9) are likewise established according to the prior art. Suitable methods have already been mentioned. A substantial advantage over the three-dimensionally formed film elements produced according to the prior art is that the at least partly transparent electrode of the electroluminescent element survives the isostatic high-pressure forming process without forming hairline cracks and without delaminating, this being achieved through the preferred use of suitable polymeric printable and electrically conductive layers. Suitable materials for producing the at least partly transparent electrode of the electroluminescent element have already been mentioned. A substantial aspect is a good adhesive bond between the at least partly transparent electrode of the electroluminescent element and the at least partly transparent support film and the other layers of the electroluminescent element, as has already been mentioned.

FIG. 5 shows a schematic view of an example of a 3D EL HPF element (1) with three EL elements (2, 15, 16) and surface-mounted SMD EL inverter elements (10). The availability of very small, flat components, such as e.g. the HV850 EL lamp driver from Supertex, Inc., in Sunnyvale, Calif., USA, which measures around 3 mm×3 mm×1 mm (H×W×D), means that these can easily be mechanically and electrically installed on the back of 3D EL HPF elements (1) using SMD technologies. Even though such EL inverters were only developed with a rating to operate an approximately 50 mm EL surface with a luminance of a few 10 cd/m², these components are very suitable for mounting directly on and immediately adjacent to the EL element. This avoids the need for long leads (6, 7) to EL elements, and the 3D EL HPF element (1) can be supplied with a DC voltage supply of for example 3 volts or 12 volts directly to the contacts (8, 9).

FIG. 6 shows a schematic view of an example of a 3D EL HPF element (1) with two EL elements (2, 15, 16) and surface-mounted SMD EL inverter elements (10) and an SMD LED element (13). Since with a high surface luminosity EL elements (2) have a reduced lifetime, it can optionally be useful selectively for certain luminous fields requiring a high signalling impact to be selectively illuminated substantially more brightly. Moreover, since SMD LED elements (13) can be mounted and connected just as easily as SMD EL inverter elements (10), it has been found that the combination of EL elements and LED elements is a very simple and efficient technology. In FIG. 6 the printed symbol for an empty tank is backlit not by an EL element (2) but by the SMD LED (13). For an additional boost to the signalling impact, small glass beads measuring a few micrometres in diameter, i.e. from 1 μm to 20 μm, preferably 1 to 5 mm, can be mixed into the translucent screen printing inks that are preferably used. Such glass beads with a refractive index of generally 1.6 to 1.9 and above can achieve an additional scattering effect, thereby increasing the signalling impact. The optimum glass bead diameter and the optimum refractive index must be matched to the chosen polymers in the printing ink binders. As already mentioned, the glass beads can be mixed with translucent printing inks (e.g. red or green or yellow or blue printing inks); however, they can likewise be incorporated into a colourless transparent printed layer.

### KEY

1 Three-dimensionally formed plastic film element produced by isostatic high-pressure forming and printed with graphic images, having at least one integrated zinc sulfide electroluminescent element (3D EL HPF element)
2 Electroluminescent (EL) element
3 Originally flat and cold-stretching film element
4 Cold-stretching graphic prints
5 Shape (trimmed or punched or laser cut edges)
6, 7 Electrical connections of an EL element
8, 9 Side edge with electrical connections
10 Surface-mounted device (SMD) EL inverter element: typically low-voltage direct current of a few volts DC in typically >60 volt, peak-to-peak AC voltage of a few 100 Hz
11, 12 Electrical connections
13 SMD LED element
14 Reference marks
15 Speedometer panel area
16 Fuel level indicator

1. A three-dimensionally formed film element constructed from
a) an at least partly transparent support film, component A, consisting of at least one cold-stretching film material, which is optionally provided with graphic images,
b) at least one electroluminescent element, component B, applied to the support film, containing the following components:
ba) an at least partly transparent electrode, component BA,
bb) optionally a first insulating layer, component BB,
bc) a layer containing at least one luminous substance which can be excited by an electric field, component BC,
bd) optionally a further insulating layer, component BD, and
be) a rear electrode, component BE, and
c) a protective layer, component CA, or a film, component CB, which can be produced by isostatic high-pressure forming of a flat film element constructed from components A, B and C at a processing temperature below the softening point of component A of the film element.

2. The three-dimensionally formed film element of claim 1, wherein the film material of the support film is at least one material selected from the group consisting of polycarbonates, polyesters, polyamides, polyimides, polyarylates, organic thermoplastic cellulose esters and polyfluorinated hydrocarbons.

3. The three-dimensionally formed film element of claim 1, wherein the support film is provided with graphic images in the form of opaque or translucent inked impressions.

4. The three-dimensionally formed film element of claim 1, wherein the at least one electroluminescent element has electrical connections which are routed along a side edge of the film element, where they are placed in contact with a power supply by contacting aids.

5. The three-dimensionally formed film element of claim 1, wherein the at least one electroluminescent element is operated with alternating current and the alternating current is generated by an SMD EL inverter.

6. The three-dimensionally formed film element of claim 1, wherein the film element further comprises at least one LED element, as component D.

7. The three-dimensionally formed film element of claim 1, wherein the at least partly transparent electrode of the electroluminescent element is a two-dimensional electrode constructed from an electrically conductive material selected from the group consisting of ITO screen-printing films, ATO screen-printing films, non-ITO screen-printing films, intrinsically conductive polymer systems, and poly-(3,4-ethylene dioxythiophene).

8. The three-dimensionally formed film element of claim 1, wherein the luminous substance includes ZnS doped with phosphorus.

9. The three-dimensionally formed film element of claim 1, wherein the rear electrode of the electroluminescent element is a two-dimensional electrode constructed from electrically conductive materials selected from the group consisting of ITO screen-printing films, ATO screen-printing films, non-ITO screen-printing films, intrinsically conductive polymer systems, and poly-(3,4-ethylene dioxythiophene), silver, or carbon, wherein silver or carbon is present within the two-dimensional electrode or present as a separate layer of these materials.

10. A process for producing a three-dimensionally formed film element comprising
i) production of a flat film element constructed from
a) an at least partly transparent support film, component A, consisting of at least one cold-stretching film material, which is optionally provided with graphic images,
b) at least one electroluminescent element, component B, applied to the support film, containing the following components:
ba) an at least partly transparent electrode, component BA,
bb) optionally a first insulating layer, component BB,
bc) a layer containing at least one luminous substance which can be excited by an electric field, component BC,
bd) optionally a further insulating layer, component BD, and
be) a rear electrode, component BE, and
c) a protective layer, component CA, or a film, component CB,
ii) isostatic high-pressure forming of the flat film element obtained in step i) at a processing temperature below the softening point of component A of the film element.

11. The process of claim 10, wherein production of the flat film element in step i) comprises the following steps:
ia) providing a transparent support film, component A, and optionally printing the transparent support film with graphic images,
ib) applying the at least one electroluminescent element to the optionally printed support film,
ic) applying the protective layer or film to the electroluminescent element;
wherein an insulating layer can optionally be applied between steps ia) and ib) and/or between steps ib) and ic).

12. A display element comprising the three-dimensionally formed film element of claim 1, wherein the display element is selected from the group consisting of a speedometer panel, a seatbelt sign, a warning sign, an electronic device housing element, a domestic appliance and a keyboard.

13. The three-dimensionally formed film element of claim 2, wherein the support film is provided with graphic images in the form of opaque or translucent inked impressions.

14. The three-dimensionally formed film element of claim 2, wherein the at least one electroluminescent element has electrical connections which are routed along a side edge of the film element, where they are placed in contact with a power supply by contacting aids.

15. The three-dimensionally formed film element of claim 2, wherein the at least one electroluminescent element is operated with alternating current and the alternating current is generated by an SMD EL inverter.

16. The three-dimensionally formed film element of claim 2, wherein the film element further comprises at least one LED element, as component D.

17. The three-dimensionally formed film element of claim 2, wherein the at least partly transparent electrode of the electroluminescent element is a two-dimensional electrode constructed from an electrically conductive material selected from the group consisting of ITO screen-printing films, ATO screen-printing films, non-ITO screen-printing films, intrinsically conductive polymer systems, and poly-(3,4-ethylene dioxythiophene).

18. The three-dimensionally formed film element of claim 2, wherein the luminous substance includes ZnS doped with phosphorus.

19. The three-dimensionally formed film element of claim 2, wherein the rear electrode of the electroluminescent element is a two-dimensional electrode constructed from electrically conductive materials selected from the group consisting of ITO screen-printing films, ATO screen-printing films, non-ITO screen-printing films, intrinsically conductive polymer systems, and poly-(3,4-ethylene dioxythiophene), silver, or carbon, wherein silver or carbon is present within the two-dimensional electrode or present as a separate layer of these materials.

20. The three-dimensionally formed film element of claim 7, wherein the film material of the support film is at least one material selected from the group consisting of polycarbonates, polyesters, and polyimides.
